(19) United States
(12) Patent Application Publication
(10) Pub. No.: US 2013/0074003 A1
(43) Pub. Date: Mar. 21, 2013

(54) METHOD AND APPARATUS FOR INTEGRATING USER INTERFACES

(71) Applicant: André Moacyr Dolenc, Espoo (FI)

(72) Inventor: André Moacyr Dolenc, Espoo (FI)

(73) Assignee: Nokia Corporation, Espoo (FI)

(21) Appl. No.: 13/238,440

(22) Filed: Sep. 21, 2011

(51) Int. Cl. G06F 3/048

(52) U.S. Cl. 715/784; 715/781

(57) ABSTRACT

An approach is provided for integrating user interfaces. A user interface (UI) platform determines a rendering of a first user interface associated with an application for presenting a least one user interface element including at least one endpoint. The UI platform further determines a first interaction with the first user interface to cause, at least in part, a revelation of the at least one endpoint. The UI platform also determines a second interaction at the least one endpoint to cause, at least in part, a transition to a second user interface associated with one or more other applications, one or more information presentations, or a combination thereof.

### BACKGROUND

Service providers and device manufacturers (e.g., wireless, cellular, etc.) are continually challenged to deliver value and convenience to consumers by, for example, providing compelling network services. Service providers often face challenges when developing user interfaces for use with the devices. Developing a user interface requires planning out the entire user interface and creating spaces within the user interface for each element. Creating a user interface that allows for the integration or inclusion of additional user interfaces requires allocating visible screen space during the user interface design phase. It is often difficult to modify previously created user interfaces for providing additional user interfaces that can provide, for example, additional information presentations or applications within the previously created user interfaces. Allocating space within user interfaces for subsequent user interfaces also takes up desirable screen space that perhaps may not be needed by subsequent user interfaces. Therefore, service providers and device manufacturers face significant technical challenges in providing a way to integrate additional user interfaces within pre-existing user interfaces.

### SOME EXAMPLE EMBODIMENTS

Therefore, there is a need for an approach for integrating user interfaces.

According to one embodiment, a method comprises determining a rendering of a first user interface associated with an application for presenting at least one user interface element including at least one endpoint. The method also comprises determining a first interaction with the first user interface to cause, at least in part, a revelation of the at least one endpoint. The method further comprises determining a second interaction at the at least one endpoint to cause, at least in part, a transition to a second user interface associated with one or more other applications, one or more information presentations, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to determine a rendering of a first user interface associated with an application for presenting at least one user interface element including at least one endpoint. The apparatus is also caused to determine a first interaction with the first user interface to cause, at least in part, a revelation of the at least one endpoint. The apparatus is further caused to determine a second interaction at the at least one endpoint to cause, at least in part, a transition to a second user interface associated with one or more other applications, one or more information presentations, or a combination thereof.

According to another embodiment, a computer-readable storage medium carries one or more sequences of one or more instructions which, when executed by one or more processors, cause, at least in part, an apparatus to determine a rendering of a first user interface associated with an application for presenting at least one user interface element including at least one endpoint. The apparatus is also caused to determine a first interaction with the first user interface to cause, at least in part, a revelation of the at least one endpoint. The apparatus is further caused to determine a second interaction at the at least one endpoint to cause, at least in part, a transition to a second user interface associated with one or more other applications, one or more information presentations, or a combination thereof.

According to another embodiment, an apparatus comprises means for determine a rendering of a first user interface associated with an application for presenting at least one user interface element including at least one endpoint. The apparatus also comprises means for determine a first interaction with the first user interface to cause, at least in part, a revelation of the at least one endpoint. The apparatus further comprises means for determine a second interaction at the at least one endpoint to cause, at least in part, a transition to a second user interface associated with one or more other applications, one or more information presentations, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of integrating user interfaces, according to one embodiment;

FIG. 2 is a diagram of the components of a user interface platform, according to one embodiment;

FIG. 3 is a flowchart of a process for integrating user interfaces, according to one embodiment;

FIG. 4 is a flowchart of a process for modifying a second user interface, according to one embodiment;

FIG. 5 is a flowchart of a process for integrating user interfaces based on context information, according to one embodiment;

FIGS. 6A-6H are diagrams of user interfaces utilized in the processes of FIGS. 3-5, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for integrating user interfaces are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to a kinetically scrolling list, it is contemplated that the approach described herein may be used with other types of user interface elements. By way of example, a user interface element may include any element that is, for example, movable (e.g., scrollable) according to some type of animation to reveal an endpoint of the user interface element and/or a user interface. An endpoint is, for example, a start and/or an end of the user interface element and/or a user interface that represents a boundary between the user interface element, and/or the user interface, and another user interface element, and/or another user interface. By way of another example, a user interface element may be an infinitely scrollable menu in the horizontal and/or vertical direction. However, in response to a pinch-zooming or corner-zooming interaction, the infinitely scrollable menu reduces in scale to reveal top, bottom, side, and/or corner endpoints. An endpoint of a user interface element or a user interface thus may be the top, the bottom, corners, and either side of the user interface element or the user interface. Exemplary user interface elements may include movable lists, movable grids, movable text blocks, movable web pages, infinitely (e.g., repeating) scrollable menus and/or forms and the like.

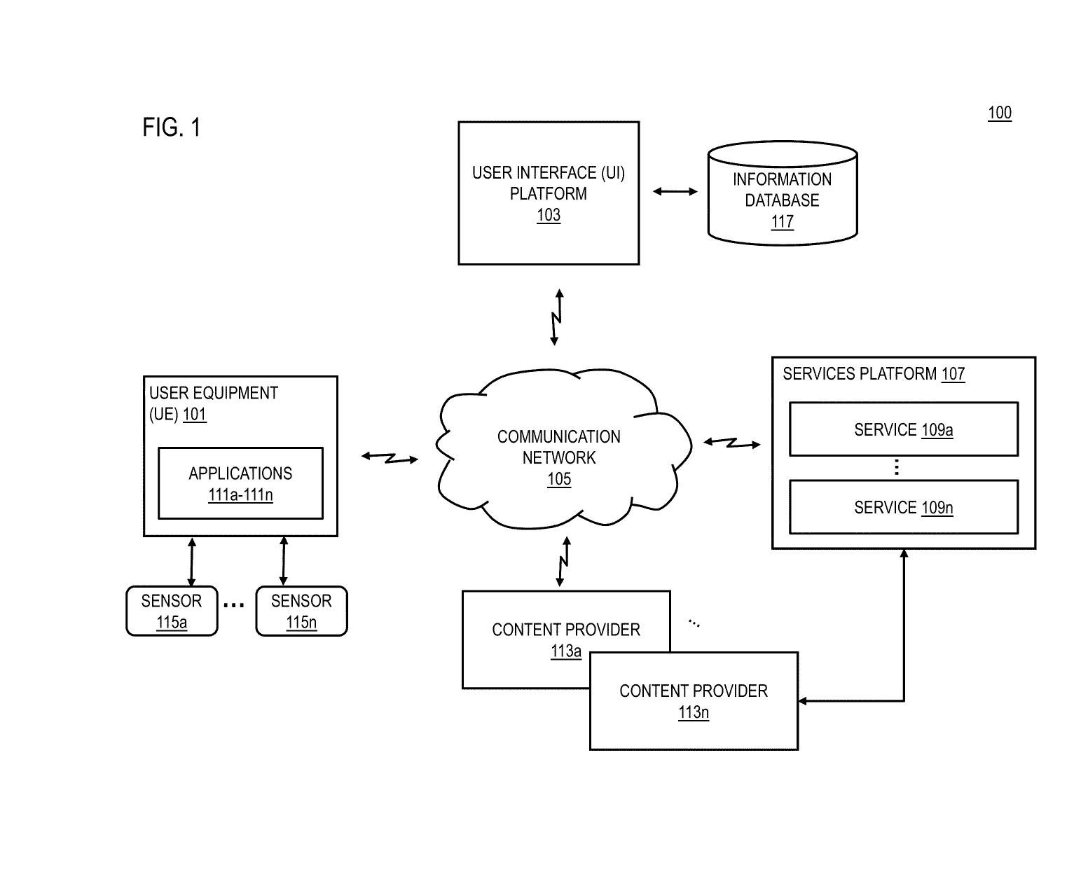

FIG. 1 is a diagram of a system capable of integrating user interfaces, according to one embodiment. As discussed above, user interfaces are often created as standalone interfaces that do not allow the incorporation of additional user interfaces, specifically third party user interfaces. Usually, each user interface is created with set elements at set locations within the user interface. Modifying the user interfaces to integrate additional elements or to integrate additional user interfaces often requires editing the code of the pre-existing user interface. Because of security reasons and/or complexity reasons, integrating third party elements or user interfaces into pre-existing user interfaces may be prohibitively complex. Also, designing user interfaces to allocate visible screen space for additional or subsequent user interfaces is often difficult because designers do not want to allocate any additional visible screen space or know what type of additional or subsequent user interfaces will be used.

To address these problems, a system 100 of FIG. 1 introduces the capability to integrate user interfaces based on elements of a pre-existing user interface in conjunction with interactions with the pre-existing user interface. The system 100 allows for determining a rendering of a first user interface associated with an application for presenting at least one user interface element including at least one endpoint. The system 100 further allows for determining a first interaction with the first user interface to cause, at least in part, a revelation of the at least one endpoint. The system 100 further allows for determining a second interaction at the at least one endpoint to cause, at least in part, a transition to a second user interface associated with one or more other applications, one or more information presentations, or a combination thereof. Thus, the system 100 allows for the integration of user interfaces based on the demand for the user to see additional user interfaces. When the user wants to see an additional user interface, the user can perform an interaction to cause the rendering of the second user interface. When the user does not want to see additional user interfaces, the user can simply not perform the interaction. Further, in one embodiment, the user can toggle off the rendering of additional user interfaces.

By way of example, a user interface associated with an application for presenting at least one user interface element may be a user interface associated with an application presenting a contacts list. The contacts list may include one or more endpoints, such as the top and bottom of the list and either side of the list. An interaction may allow scrolling through the contacts list and, as a result of the interaction, may cause a bounce-back animation if the scrolling continues after one of the endpoints is reached. For example, when scrolling through the list to reach the top of the list, upon reaching the top of the list while still scrolling, an endpoint at the top of the list is revealed. Upon stopping scrolling through the contacts list without any further interaction, the contacts list bounces back with a bounce-back animation to hide the endpoint. However, a second interaction may cause a transition to the second user interface at the endpoint and an activation of the second user interface. Thus, no modification of the first user interface is required to integrate the second user interface. Rather, the second user interface may be integrated with the first user interface by using the properties of the first user interface, such as the bounce-back animation at an endpoint.

The second user interface may be independent of the first user interface such that the second user interface represents a different one or more applications and/or one or more information presentations than the first user interface. Thus, for example, the second user interface is created independently from the first user interface and can be created dynamically upon revelation of an endpoint associated with the first user interface. Accordingly, user interfaces can be integrated without having to explicitly design the user interfaces for integration.

In one embodiment, for example, the second user interface may represent a separate and distinct application that is running in the background of the first user interface (e.g., multitasking). Accordingly, when creating the second user interface, consideration of the first user interface (e.g., size of the first user interface, position of the first user interface, etc.) is not necessary. For example, the second user interface may be revealed, or activated, to comprise the space the first user interface comprises, may share the space the first user interface comprises, may be larger than the first user interface, may comprise the entire screen associated with a display, etc.

In one embodiment, the second user interface may also be movable based on an interaction and may be, for example, movable lists, movable grids, movable text blocks, movable web pages, infinitely (e.g., repeating) scrollable menus and/or forms and the like. For example, the second user interface may be infinitely scrollable in the horizontal and/or vertical directions. In one embodiment, the second interface can be moved based on one or more interactions to reveal one or more endpoints associated with the second interface, and to reveal and/or transition to a third user interface, such that the process of transitioning from one user interface to another user interface may be iterative (e.g., transition to third, fourth, fifth, etc. user interfaces).

In one embodiment, the second interaction may be any type of interaction, such as a long-hold for a defined duration, a flick up and/or down, a scratch, or the like. The transition between the first user interface and the second user interface may occur based on when the second interaction satisfies a pre-defined interaction. For example, the transition may occur when the duration of a long-hold meets or exceeds a predetermined threshold value.

In one embodiment, a third interaction with the second user interface causes a return to the first user interface. By way of example, the second user interface may include a user interface element that, when selected by a third interaction, returns the user interface to the first user interface. The third interaction may be any type of interaction, such as a long-hold for a defined duration, a flick up and/or down, a scratch, or the like. The device associated with the first user interface and the second user interface may also include a hardware element that, when activated, causes the first user interface to return. In one embodiment, a portion of the first user interface, or a representation of the first user interface, remains visible after activation of the second user interface. An interaction with the first user interface, or the representation of the first user interface, causes the second user interface to return to the first user interface.

In one embodiment, where the second user interface includes one or more applications, the one or more applications may be activated by a second interaction during the transition, after the transition, or a combination thereof. Upon being activated, the user can interact with the one or more applications. By way of example, when the first user interface is a kinetically scrolling list, as the list is scrolling down to reveal the second user interface, a second interaction may activate one or more applications associated with the second user interface. Such a second interaction may be, for example, a tap on the second user interface or a flick up and/or down on the second user interface. By way of further example, when the first user interface is a kinetically scrolling list, after then list is scrolled down to reveal the second user interface, a second interaction may activate one or more applications associated with the second user interface. Such a second interaction may be, for example, a long-hold for a defined duration.

In one embodiment, the second user interface that is transitioned to from the first user interface may be associated with one or more information presentations. Upon activating the second user interface, the second user interface may become associated with one or more applications that are related to the one or more information presentations. By way of example, upon transitioning to the second user interface, the second user interface may by associated with an information presentation in the form of, for example, an animated GIF. Upon activating the second user interface, the second user interface may become associated with an application that is related to the information presentation (the animated GIF).

In one embodiment, the system 100 determines a bookmark associated with a point in time in which the application associated with the second user interface is stopped and the second user interface is returned to the first user interface. In a subsequent activation of the application, the system 100 may determine to start the application at the bookmark.

In one embodiment, upon revealing the second user interface, the one or more applications and/or one or more information presentations associated with the second user interface may be alternated each time the second user interface is revealed and/or while the second user interface is revealed. By way of example, for a kinetically scrolling list (or a movable form and the like), each time the top of the list is reached and the scrolling continues thereby revealing the second user interface, a different application and/or information presentation may be revealed. Further, by way of example, for a kinetically scrolling list (or a movable form and the like), each time the top of the list is reached and the scrolling continues thereby revealing the second user interface, a different application and/or information presentation may be revealed associated with the second user interface as compared to if the bottom of the list is reached and the scrolling continues thereby revealing the second user interface. Further, by way of example, while the second user interface is revealed, an interaction with the second user interface may cause the second user interface to alternate between one or more applications, or one more information presentations, or a combination thereof.

In one embodiment, when the second user interface is associated with one or more applications, the one or more applications are represented by images associated with the second user interface, and the one or more applications are revealed upon activating the one or more images.

In one embodiment, a transition of the first user interface to reveal the second user interface may vary between different transitions effects. By way of example, the rendering of the first user interface may be modified with a transparency effect to show the second user interface behind a semi-transparent first user interface. Further, by way of example, the rendering of the first user interface during an animation of, for example, moving up or down, may reveal the second user interface moving in conjunction with the first user interface. In one embodiment, any one or all of the transition effects may be associated with revealing the second user interface.

In one embodiment, a user may indicate preference information with respect to the one or more applications, the one or more information presentations, or a combination thereof associated with the second user interface. The user may indicate the preference information with a fourth interaction with the first user interface, the second user interface, or a combination thereof. The user preference information may indicate, for example, a preference to include or exclude one or more applications, one or more information presentations, or a combination thereof. The user preference information may also indicate, for example, whether to reveal the second user interface such that the second user interface is not revealed in association with any first interaction.

In one embodiment, the second interaction is at least one gesture that is not used in the first user interface, the application associated with the first user interface, or a combination thereof.

In one embodiment, the system 100 determines context information associated with the first user interface, the at least one user interface element, a device associated with the first user interface, or a combination thereof and determines the transition, the second user interface, the one or more applications, the one or more information presentations, or a combination thereof based, at least in part, one the context information. By way of example, the system 100 may determine that the application associated with the first user interface is a contacts list. Upon revealing the second user interface, the system 100 may include an application in the second user interface such as a national phonebook, a calendar application, or a combination thereof.

As shown in FIG. 1, the system 100 comprises user equipment (UE) 101 having connectivity to a user interface (UI) platform 103, a services platform 107, and content providers 113a-113n (collectively referred to a content providers 113) via a communication network 105. One or more applications 111a-111n (collectively referred to as applications 111) may be executed by the UE 101. Each one of the applications 111 may be associated with a specific user interface. The applications 111 may include a navigation application, a calendar application, a web browser application, a contacts list application, a settings application, etc. The applications may provide context information associated with the UE 101 and/or the user of the UE 101. For example, the navigation application may provide a location of the UE 101, the calendar application may provide an appointment associated with the user of the UE 101, a contacts list application may provide one or more contacts (e.g., family members, friends, co-workers) associated with the user of the UE 101, etc. Connected to, or part of, the UE 101 may be one or more sensors 115a-115n (collectively referred to as sensors 115). The sensors may be used to provide additional context information associated with the UE 101 and/or the user of the UE 101. For example, one of the sensors 115 may include a GPS sensor for providing location information associated with the UE 101, a light sensor for providing information regarding the lighting surrounding the UE 101, etc.

The UI platform 103 integrates one or more user interfaces, as described herein. Although illustrated as a separate element within the system 100, the UI platform 103 may be embodied in, for example, the UE 101 as an application running on the UE 101. The UI platform 103 may also be provided as a service 109a running on the services platform 107. In communication with the UI platform 103 is an information database 117. The information database 117 may include one or more applications, one or more information presentations, or a combination thereof for presenting within a second user interface at the UE 101.

The system 100 also includes the services platform 107 that includes one or more services 109a-109n (collectively referred to as services 109) for the system 100. The services 109 may encompass navigation services, location-based services, contacts-based services, appointment-based services, or the like. The system 100 also includes content providers 113 that may provide content to one or more services 109 on the services platform 107, to the UI platform 103, and to the UE 101. The content may include, for example, one or more applications, one or more information presentations, or a combination thereof provided by the UI platform 103 to the UE 101 associated with a second user interface.

By way of example, the communication network 105 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, the UI platform 103, the services platform 107, and the content providers 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

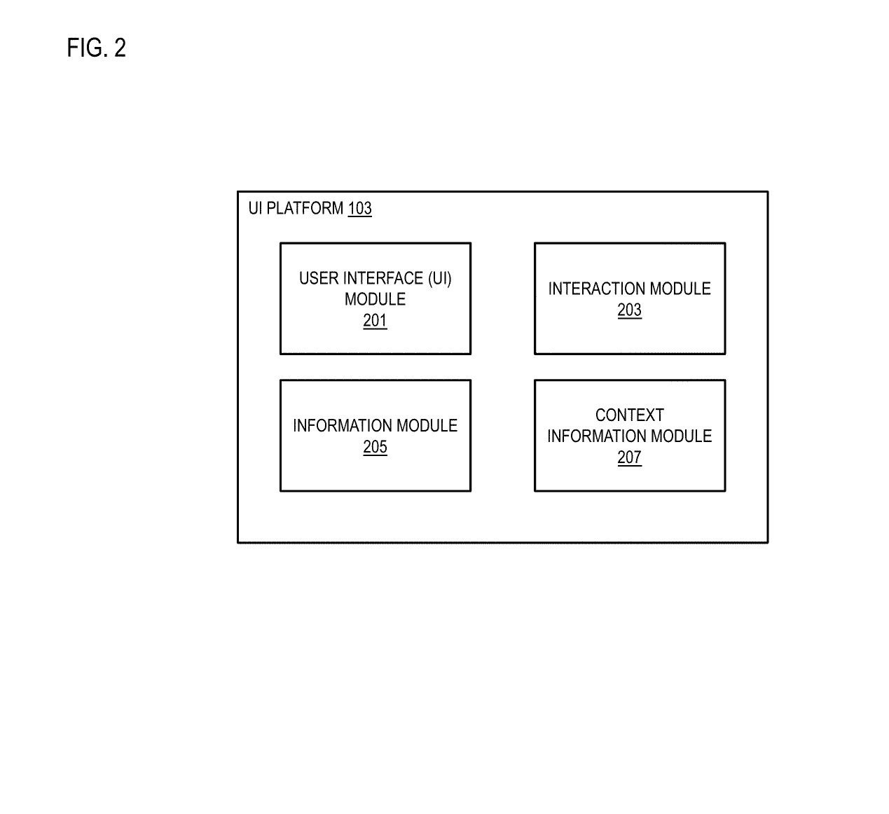

FIG. 2 is a diagram of the components of the UI platform 103, according to one embodiment. By way of example, the UI platform 103 includes one or more components for integrating user interfaces. It is contemplated that the functions of these components may be combined in one or more components or performed by other components of equivalent functionality. In this embodiment, the UI platform 103 includes a user interface (UI) module 201, an interaction module 203, an information module 205, and a context information module 207.

In one embodiment, the UI module 201 controls the aspects of the UI platform 103 concerning the user interfaces at the UE 101. In one embodiment, the UI module 201 determines whether a user interface associated with the UE 101 is associated with a user interface element, as discussed above. By way of example, a user interface element list can be a list of repetitive elements, such as a list of contacts in a mobile device, where an interaction with the list of elements causes the revelation of an endpoint of the list. The endpoint may be, for example, the top of the list, the bottom of the list, or either side of the list. A user interface element can also be, for example, a movable form where the form as a whole moves in response to an interaction to reveal an endpoint. For example, the interaction may include a pinch-zooming that reveals the side endpoints of the movable form (for a pinch-zooming near the middle of the list of elements) or the side endpoints and either a top or a bottom endpoint (for a pinch-zooming near the top or bottom of a list of elements). The UI module 201 makes the determination to determine whether there can be a transition between the first user interface and a second user interface. The UI module 201 determines that there can a transition between the first user interface and a second user interface for any user interface that includes an endpoint that can be revealed.

The UI module 201 also controls the transitions between the first user interface and the second user interface at the UE 101. The transitions can include, for example, a kinetic animation of the first user interface, the second user interface, or a combination thereof while the first user interface, the second user interface, or the combination thereof remains static. Thus, for example, for a kinetically scrolling list, a transition may include the first user interface scrolling up or down to reveal the second user interface, while the second user interface remains static. In addition, a transition may include the first user interface scrolling up or down to reveal the second user interface that is also scrolling up or down in conjunction with the first user interface.

The UI module 201 may also control the transitions to include other characteristics. By way of example, the UI module 201 may change the transparency of the first user interface to reveal the second user interface. For example, as the user performs an interaction, the first user interface may become semi-transparent to reveal the second user interface behind the first user interface. In addition, as the user performs an interaction, the first user interface may appear to have vertical, horizontal, or a combination thereof stripes appear that reveal the second user interface behind the first user interface.

The UI module 201 also controls the transitions back to the first user interface from the second user interface. After the UI platform 103 determines that a user of the UE 101 decides to revert back to the first user interface, the UI module 201 may transition from the second user interface back to the first user interface according to any of the above-discussed methods for transitioning from the first user interface to the second user interface.

For applications that are associated with the second user interface, in one embodiment, the UI module 201 represents the applications with images (e.g., bitmaps) representing the one or more applications until the applications are activated.

In one embodiment, the interaction module 203 determines the interactions associated with the first user interface, the second user interface, the device associated with the first user interface and the second user interface, or a combination thereof in association with integrating a first user interface with a second user interface. An interaction may include one or more gestures associated with controlling the first user interface, the second user interface, the device associated with the first user interface and the second user interface, or a combination. In one embodiment, an interaction may include a meta interaction that is recognized by the UI platform 103 and is not recognized by the first user interface or the second user interface. Meta interactions may include interactions obtained through audio and/or image input sensors 115 (e.g., microphone, camera, and the like). Meta interactions may include, for example, voice commands associated with voice recognition capabilities and gestures associated with image recognition capabilities (e.g., hand gestures, facial gestures, and the like). By way of example, image recognition capabilities can determine a user's response to an information presentation associated with a second user interface based on the facial gestures of the user (e.g., smile, frown, change).

Meta interactions may represent one of at least three responses, such as a positive response, a negative response, and a neutral response (e.g., no change or not interested). By way of example, a positive meta interaction indicates that the user likes an application and/or information presentation associated with a second user interface. Such an interaction may be determined by recognizing a smile on the user's face upon presenting the second user interface, or recognizing a shake of the user's head or hand. A negative meta interaction indicates that the user dislikes the application and/or information presentation associated with the second user interface. Such an interaction may be determined by recognizing a frown on the user's face upon presenting the second user interface. A neutral response for a meta interaction indicates the user is neither interested nor disinterested (e.g., not relevant) with the application and/or information presentation associated with the second user interface.

The interaction module 203 initially determines an interaction associated with a first user interface and determines whether the interaction is associated with a revelation of at least one endpoint of the user first user interface.

By way of example, the interaction module 203 monitors the interactions associated a list of contacts, for example, and determines whether one of the interactions causes a revelation of an endpoint of the list of contacts. The interaction may include, for example, any interaction that causes the list to reach the top or bottom of the list (e.g., scrolling to top or bottom). The interaction may also include, for example, any interaction that causes the list to contract (e.g., pinch-zoom, corner-zooming, and the like) to reveal side endpoints. For example, if the list of contacts is long, rather than scrolling to the top or bottom of the list of contacts to reveal the top or bottom endpoints, a user can simply use a pinch-zoom interaction to reduce the scale of the list of contacts and reveal the side endpoints (or side endpoints and the top or the bottom endpoint if close enough to the top or bottom of the list). The user may also use a corner-zooming interaction to reduce the scale of the list of contacts and reveal the top, bottom and/or side endpoints.

Such interactions may be inputted and/or detected by any known means. For example, such interactions may be associated with a graphical representation of a cursor associated with an input device (e.g., one or more keys of a keyboard, a roller ball, a mouse, a touch sensitive pad, and the like). Such interactions may also be associated with a touch-sensitive display, where the cursor is represented by, for example, a stylus, one or more of the user's fingers, or a combination thereof. Such interactions may also be associated with hardware elements associated with the UE 101, such as, for example, buttons associated with a camera zoom function that correlate to a pinch-zooming effect.

Upon determining an interaction with the first user interface that causes a revelation of an endpoint, the interaction module 203 further monitors for a second interaction. The interaction module 203 determines the type of interaction and the duration of the interaction. For example, the interaction module 203 can determine if the interaction is a flick up and/or down interaction, a scratch interaction, a pinch-zoon interaction, or a long-hold interaction. For the long-hold interaction, the interaction module 203 further determines the duration of the long-hold. The interaction module 203 determines whether any of the interactions satisfies pre-defined interactions for causing a transition between the first user interface and the second user interface.

By way of example, a first interaction with a first user interface may be a dragging of the first user interface down across a display to reveal an endpoint. The second interaction may be a continuation of the dragging of the first user interface and the endpoint to cause a transition to (e.g., revelation of) the second user interface, behind the first user interface.

By way of a further example, a first interaction with the first user interface may be a pinch-zooming or a corner-zooming of the first user interface to reveal the side endpoints of the first user interface. If the pinch-zooming interaction is held for less than a pre-defined duration and released, the first user interface may bounce back to the original scale. However, if the pinch-zooming interaction is held for longer than a pre-defined duration before being released, the first user interface may transition to the second user interface such that, for example, the second user interface appears in the background on either side of the first user interface.

The interaction module 203 further determines whether there is an interaction with the first user interface, the second user interface, or a combination thereof that satisfies a pre-defined interaction for transitioning back to the first user interface from the second user interface. Such an interaction may include any of the above-discussed interactions. Further, certain locations of the first user interface or the second user interface may correspond to elements that, if selected based on any type of interaction, correspond to transitioning back to the first user interface from the second user interface. By way of example, the second user interface may include a user interface element such as an X that corresponds to transitioning back to the first user interface. In one embodiment, the UE 101 may include a hardware element that is associated with returning the second user interface back to the first user interface.

In one embodiment, the transition to the second user interface may comprise the second user interface occupying substantially all of the display or substantially all of the display that the first user interface occupied. A portion of the first user interface, or a representation of the first user interface, may remain to allow the user to interact with to return the second user interface back to the first user interface.

In one embodiment, the interaction module 203 further determines whether there is an interaction associated with the first user interface, the second user interface, or a combination thereof, associated with an activation of one or more applications, one or more information presentations, or a combination thereof associated with the second user interface. The interaction module 203 monitors for the interaction during and/or after the transition between the first user interface and the second user interface.

In one embodiment, the interaction module 203 further determines whether there is an interaction associated with the first user interface, the second user interface, one or more applications associated with the second user interface, one or more information presentations associated with the second user interface, or a combination thereof that indicate an alternation of the one or more applications, the one or more information presentations, or a combination thereof. By way of example, the user of the UE 101 may interact with the second user interface associated with one or more applications to alternate between the applications. For example, the user may use one or more gestures, such as a flick, a swipe, or the like, to alternate between one or more applications so that the user can choose the application that is associated with the second user interface.

In one embodiment, the interaction module 203 further determines whether there is an interaction associated with the first user interface, the second user interface, one or more applications associated with the second user interface, one or more information presentations associated with the second user interface, or a combination thereof that indicate a preference associated with respect to the one or more applications, the one or more information presentations, or a combination thereof. The user preference information may include, for example, information pertaining to the whether the user prefers or does not prefer certain applications and/or information presentations. The user preference information also may include, for example, information pertaining to whether the user toggles on or off the rendering of a second user interface based on an interaction associated with the first user interface.

In one embodiment, the information module 205 controls the information is the presented in the second user interface. The information module 205 interfaces with the information database 117 to provide the one or more applications and/or the one or more information presentations to the UI module 201 for presenting in the second user interface at the UE 101. The information module 205 also interfaces with the interaction module 203 to determine the user preference information associated with the second user interface. By way of example, the information module 205 determines from the interaction module 203 the preference of a user as to the type of applications and/or information presentations to include in the second user interface. The information module 205 also interfaces with the context information module 207 (discussed below) to determine the context information for presenting one or more applications and/or one or more information presentations that are associated with the context information.

In one embodiment, the context information module 207 determines the context information associated with the first user interface, at least one user interface element associated with the first user interface, a device associated with the first user interface, a user associated with the device, or a combination thereof. The context information module 207 interfaces with the UI module 201 to determine, for example, the one or more applications, the one or more information presentations, or a combination thereof that are presented associated with the second user interface. The context information module 207 also interfaces with the applications 111 and/or sensors 115 associated with the UE 101 for determining the context information.

By way of example, the context information module 207 determines the context information associated with the device regarding the location of the device. Based on the location of the device, the context information module 207 interfaces with the UI module 201 and the information module 205 to present one or more applications, one or more information presentations, or a combination thereof based on the location of the device. Such one or more applications may include, for example, applications associated with a phonebook the covers the location of the device. According to this approach, the context information module 207 may provide the user of the device with applications, information presentations, or combinations thereof based on the context information.

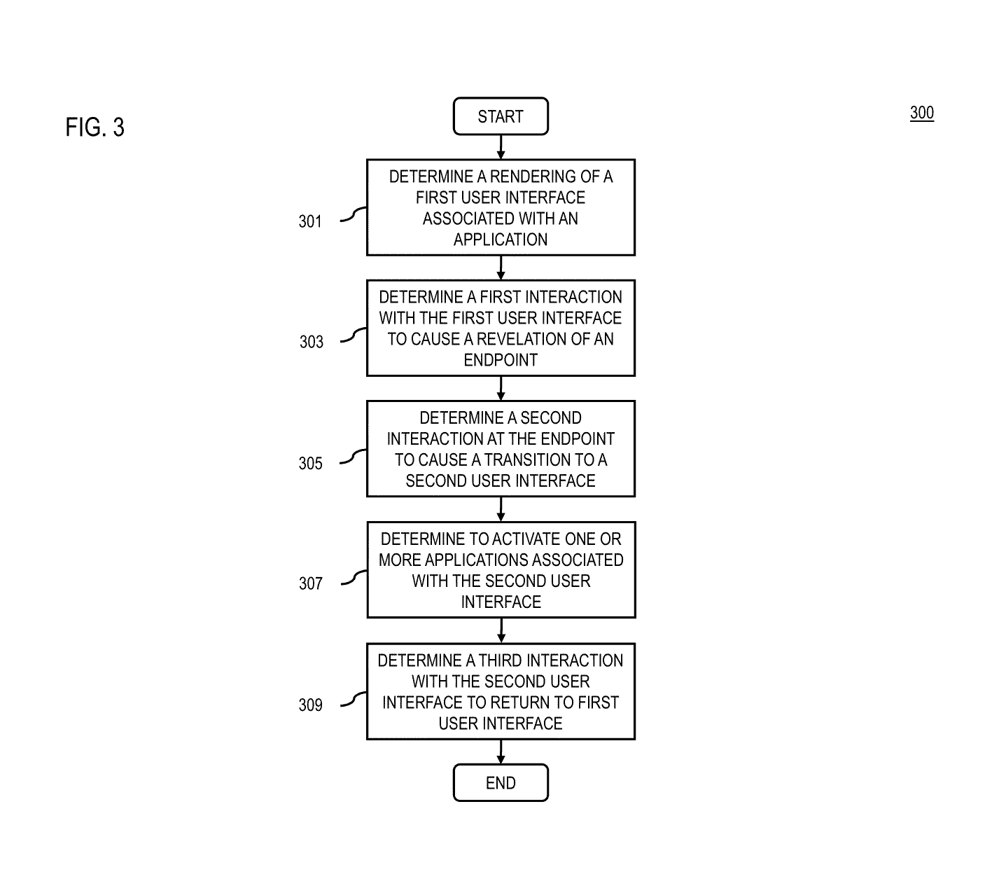

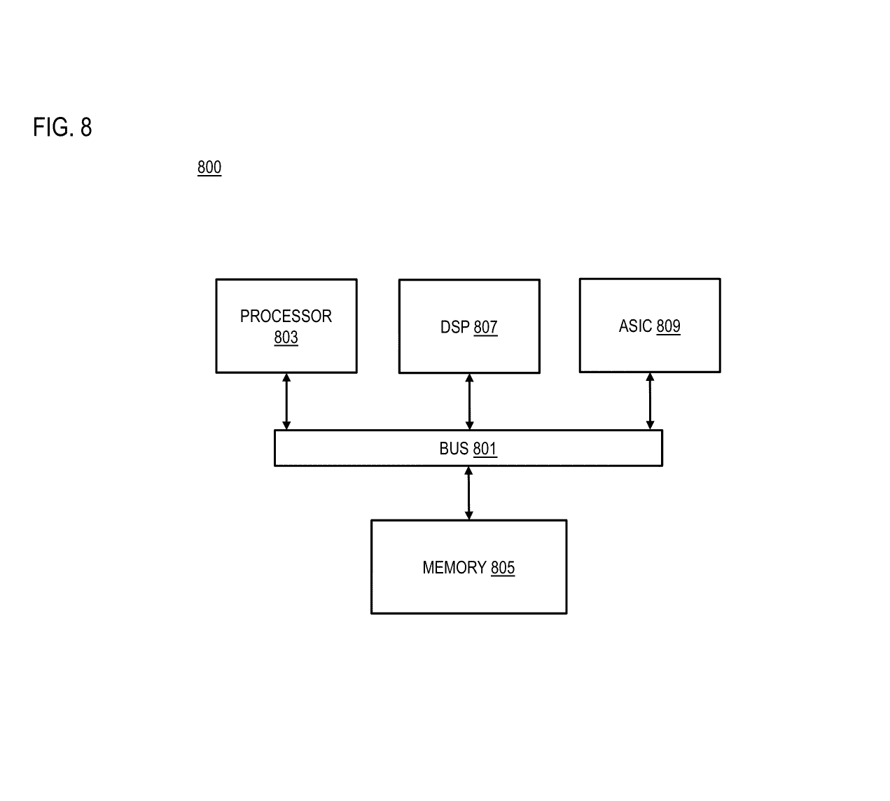

FIG. 3 is a flowchart of a process for integrating user interfaces, according to one embodiment. In one embodiment, the UI platform 103 performs the process 300 and is implemented in, for instance, a chip set including a processor and a memory as shown in FIG. 8. In step 301, the UI platform 103 determines whether there is a rendering of a first user interface associated with an application for presenting at least one user interface element at the UE 101. As discussed above, a user interface element may encompass any element that includes an endpoint that may be revealed, such as a top endpoint, a bottom endpoint, or a side endpoint. For example, a user interface element may include multiple elements categorized in a list that can be scrolled through to select one element among the multiple elements. The endpoints of such a list would include a top endpoint, a bottom endpoint, and two side endpoints. The top endpoint and the bottom endpoint may be revealed by scrolling to the top and bottom of the user interface element. The two side endpoints may be revealed by pinch-zooming the user interface element to reduce the size of the user interface element with respect to its original size. A list may also include, for example, a movable form of user interface elements that includes a top endpoint, a bottom endpoint and two side endpoints.

In step 303, the UI platform 103 determines whether there is a first interaction associated with the first user interface that causes a revelation of an endpoint of the first user interface. By way of example, for a kinetically scrolling list, a first interaction associated with the list may include an interaction that reveals the top of the list or the bottom of the list. Where the kinetically scrolling list is long, such that it would take a large amount of scrolling to reach the top of the list or the bottom of the list, the first interaction associated with the list may include a pinch-zoom interaction that causes a revelation of the sides of the lists. Alternatively, where the list is long, the first interaction associated with the list may include a flick up or a flick down that causes the top or the bottom of the list to be revealed substantially instantly, respectively.

In step 305, the UI platform 103 determines whether there is a second user interaction at the revelation of the endpoint to cause a transition to a second user interface. In one embodiment, the same interaction that constitutes the first interaction may, after revelation of the endpoint, also constitute the second interaction. For example, for a kinetically scrolling list, an interaction that causes the revelation of the endpoint may constitute a dragging of a cursor over the first user interface to scroll through the list until the top of the list (e.g., endpoint) is reached. A continuation of dragging the cursor will cause the top of the list to continue scrolling down, thereby revealing a second user interface above the first user interface. For a further example, for a first user interface that is, for example, an infinitely scrollable menu, a first pinch-zooming or corner-zooming interaction may cause the side endpoints to be revealed. A second pinch-zooming interaction, which may be a continuation of the first pinch-zooming interaction, may cause the second user interface to be revealed on either side of the first user interface, after the first user interface is reduced in scale.

In one embodiment, a different interaction than the first interaction constitutes the second interaction. For example, for a kinetically scrolling list, an interaction that causes the revelation of the endpoint may constitute a dragging of a cursor over the first user interface to scroll through the list until the top of the list (e.g., endpoint) is reached. A second interaction, such as a long-hold of the cursor may cause a transition to the second user interface. Alternatively, the second interaction may be associated with a hardware element of the UE 101 at the revelation of the endpoint, such as controlling a zoom out button associated with camera controls of the UE 101 to cause the effect of a pinch-zooming or corner-zooming on the first user interface to transition to the second user interface.

In one embodiment, the second interaction is at least one gesture that is not used with the first user interface, an application associated with the first user interface, or a combination thereof. For example, performing the second interaction associated with the first user interface prior to performing the first interaction that causes a revelation of an endpoint does not cause a change in the first user interface. It is only when the second interaction is performed after the first interaction that the transition occurs between the first user interface and the second user interface.

As discussed above, a transition of the first user interface to the second user interface may constitute any type of visible transition. By way of example, a transition may include a kinetic first user interface moving to reveal a static second user interface, a kinetic first user interface moving to reveal a kinetic second user interface that is moving in conjunction with the first user interface. A transition may also include the first user interface becoming semi-transparent to reveal the second user interface behind the first user interface. A transition may also include the vertical, horizontal, or a combination thereof stripes through the first user interface revealing the second user interface behind the first user interface. A transition may also include the first user interface moving to reveal a blank background based on the first interaction. Upon the second interaction, the blank background may transition to the second user interface according to a fade in transition or some other type of transition. If the second interaction is not performed, the first user interface may bounce back to no longer reveal the endpoint.

In one embodiment, each time the UI platform 103 determines to transition between a first user interface and a second user interface, the UI platform 103 can choose a different independent and/or distinct application and/or information presentation to associate with the second user interface. Additionally, depending on the type of transition, the UI platform 103 can choose a different application and/or information presentation to associate with the second user interface. By way of example, if the transition between the first user interface and the second user interface involved a revelation of the top endpoint of the list associated with the first user interface, a first application may be associated with the second user interface. Further, if the next transition between the first user interface and the second user interface involved a revelation of the bottom endpoint of the list associated with the first user interface, a second application, different than the first application, may be associated with the second user interface. Thus, the user of the UE 101 may cycle through the applications and/or information presentations associated with the second user interface by varying the endpoint associated with the transition.

In step 307, the UI platform 103 determines whether there is an interaction associated with the first user interface, the second user interface, or one or more applications or one or more information presentations associated with the second user interface that activates the one or more applications or the one or more information presentations. The interaction may constitute, for example, a long-hold for a pre-defined duration or longer over the second user interface to activate the one or more application or the one or more information presentations associated with the second user interface.

In one embodiment, the UI platform 103 remembers the points in time where applications are activated and deactivated. Thus, for example, an application may be reactivated to the point in time that the application was previously deactivated.

In one embodiment, when the second user interface is activated, the second user interface occupies all, part of, or more of the portion of a display that the first user interface occupied, substantially all of the display, or a combination thereof. By way of example, upon activating an application associated with the second user interface, the application may expand to occupy substantially the entire display associated with the UE 101.

In step 309, the UI platform 103 determines whether there is another interaction associated with the second user interface to return to the first user interface. By way of example, any one of the above-discussed interactions can be associated with the second user interface to cause the second user interface to return back to the first user interface. For example, a pinch-zooming interaction with the second user interface may cause the second user interface to transition back to the first user interface. In one embodiment, the second user interface may include a specific element that is associated with a specific interaction for returning back to the first user interface. For example, the second user interface may include a symbol that, when selected using an interaction with a cursor, returns the second user interface back to the first user interface. For example, a portion of the first user interface, or a representation of the first user interface, may remain visible after activation of the second user interface. An interaction with the portion of the first user interface that is visible, or the representation of the first user interface that is visible, may return the second user interface to the first user interface.

In one embodiment, the UE 101 may include a hardware element that can correspond with an action of returning the second user interface to the first user interface. For example, the UE 101 may include a hardware element such as a button that returns the display of the UE 101 back to the first user interface from the second user interface. Also, for example, the UE 101 may include a camera and include a hardware element, such as a zoom in button, that controls the action of returning the second user interface to the first user interface according to a pinch-zooming animation. After step 309, the process 300 ends.

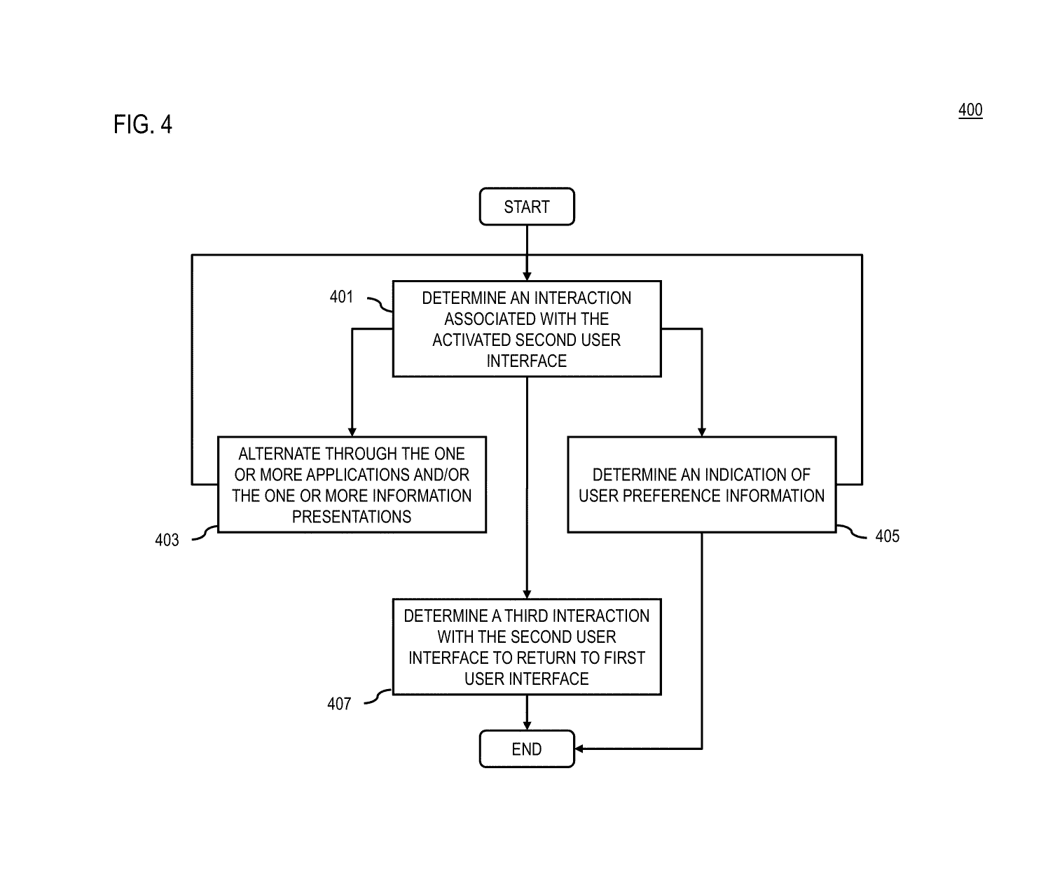

FIG. 4 is a flowchart of a process for modifying the second user interface, according to one embodiment. In one embodiment, the UI platform 103 performs the process 400 and is implemented in, for instance, a chip set including a processor and a memory as shown in FIG. 8. In step 401, the UI platform 103 determines an interaction associated with the second user interface. The interaction may be any of the interactions discussed above that is pre-defined to correspond with a certain function.

In the event that the interaction is associated with is an alternation between one or more applications and/or one or more information presentation, the process 400 proceeds to step 403. In step 403, the UI platform 103 alternates between displayed applications and/or information presentations associated with the second user interface that has already been revealed at the UE 101. In one embodiment, the interaction to alternate between the applications or information presentations is associated with the second user interface generally. For example, the interaction can be any type of pre-defined interaction anywhere with respect to the second user interface. In one embodiment, the interaction is associated with visual elements within the second user interface. For example, the elements within the second user interface may constitute, for example, arrows indicating an alternating direction between the applications and/or information presentations associated with the second user interface.

In one embodiment, once the second user interface becomes active, the UI platform 103 can determine one or more meta interactions. Thus, the interaction determined at step 401 may be a meta interaction, and the meta interaction may be associated with an alternation between one or more applications and/or one or more information presentations. By way of example, a positive or negative meta interaction associated with an application and/or information presentation may indicate whether the user wants to alternate to another application and/or information presentation. For example, if the user shakes his or her head indicating a negative response to an information presentation, the UI platform 103 can determine the negative meta interaction and alternate to a different information presentation. If the user shakes his or her head indicating a positive response to an information presentation, the UI platform 103 can determine the positive meta interaction and have the information presentation remain associated with the second user interface.

After step 403, the process 400 proceeds back to step 401.

In the event that the interaction is associated with an indication of user preference information associated with the one or more applications and/or one or more information presentations associated with the second user interface, the process 400 proceeds to step 405. In step 405, the UI platform 103 determines what type of preference information associated with the interaction. In one embodiment, one interaction may indicate whether the user likes or dislikes the application or information presentation associated with the second user interface. In which case, the UI platform 103 can provide other applications and/or information presentations based on the user's indication.

In one embodiment, once the second user interface becomes active, the UI platform 103 can determine one or more meta interactions. Thus, the interaction determined at step 401 may be a meta interaction, and the meta interaction may be associated with user preference information. By way of example, a positive or negative meta interaction associated with an application and/or an information presentation may indicate the user's preference regarding the application and/or the information presentation. A positive meta interaction may indicate that the user enjoys the specific application and/or information presentation. A negative interaction may indicate that the user does not enjoy the specific application and/or information presentation. Thus, the UI platform 103 monitors the meta interactions to determine user preference information so that the UI platform 103 can, for example, provide preferred applications and/or user information presentations to the user.

In one embodiment, one interaction may indicate that the user no longer wants to transition to second user interfaces based on interactions with the first user interface. Thus, the user can toggle off the UI platform 103. If the user performs an interaction to toggle off the UI platform 103, the process 400 ends. Otherwise, the process 400 proceeds back to step 401.

In step 407, as discussed above with respect to step 309 in process 300, the UI platform 103 determines that there is an interaction associated with the second user interface to return to the first user interface. Upon determining the interaction, the process 400 ends.

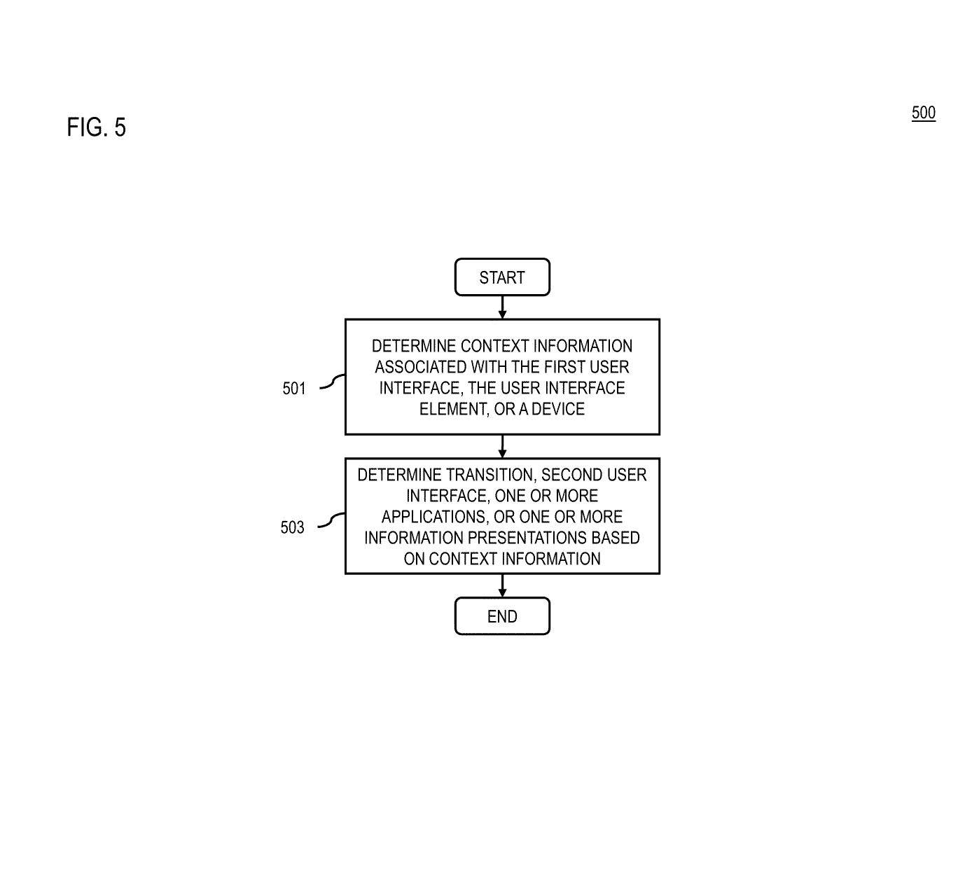

FIG. 5 is a flowchart of a process for integrating user interfaces based on context information, according to one embodiment. In one embodiment, the UI platform 103 performs the process 500 and is implemented in, for instance, a chip set including a processor and a memory as shown in FIG. 8. In step 501, the UI platform 103 determines context information associated with the first user interface, the user interface element associated with an application of the first user interface, the UE 101 associated with the first user interface, the user associated with the UE 110, or a combination thereof. The context information associated with the first user interface or the user interface element associated with an application of the first user interface may constitute information pertaining to the type of user interface element and/or application of the first user interface. For example, an application related to a contacts list associated with the first user interface may indicate that the user is looking for a certain contact within the UE 101. An application related to an appointment book or a calendar may indicate that the user is looking for a certain appointment or location related to an appointment. The context information associated with the UE 101 associated with the first user interface may indicate the location of the UE 101.

In step 503, the UI platform 103 determines a transition between the first user interface and the second user interface, the second user interface, one or more applications, or one or more information presentations based on the context information determined in step 503. By way of example, when the first user interface is associated with an application related to a contacts list, the second user interface may present an independent and/or distinct, yet related application, such as an application related to a phonebook. When the first user interface is associated with an application related to an appointment book or a calendar, the second user interface may present an independent and/or distinct, yet related application, such as an application related to planning events. When the UI platform 103 determines the location of the UE 101 that is associated with the first user interface, the UI platform 103 can further tailor the applications and/or information presentations at the UE 101 based on the location of the UE 101. For example, the second user interface may present an application related to a phonebook that covers the current location of the UE 101. After step 503, the process 500 ends.

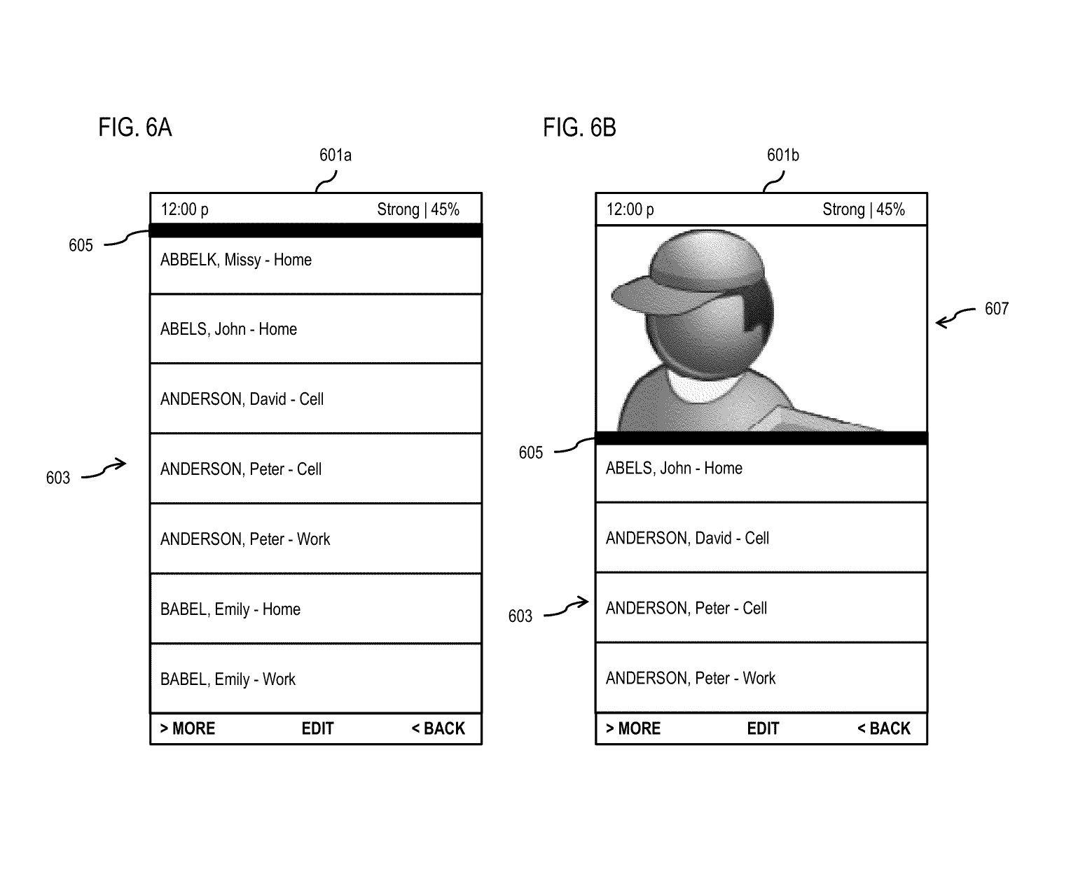

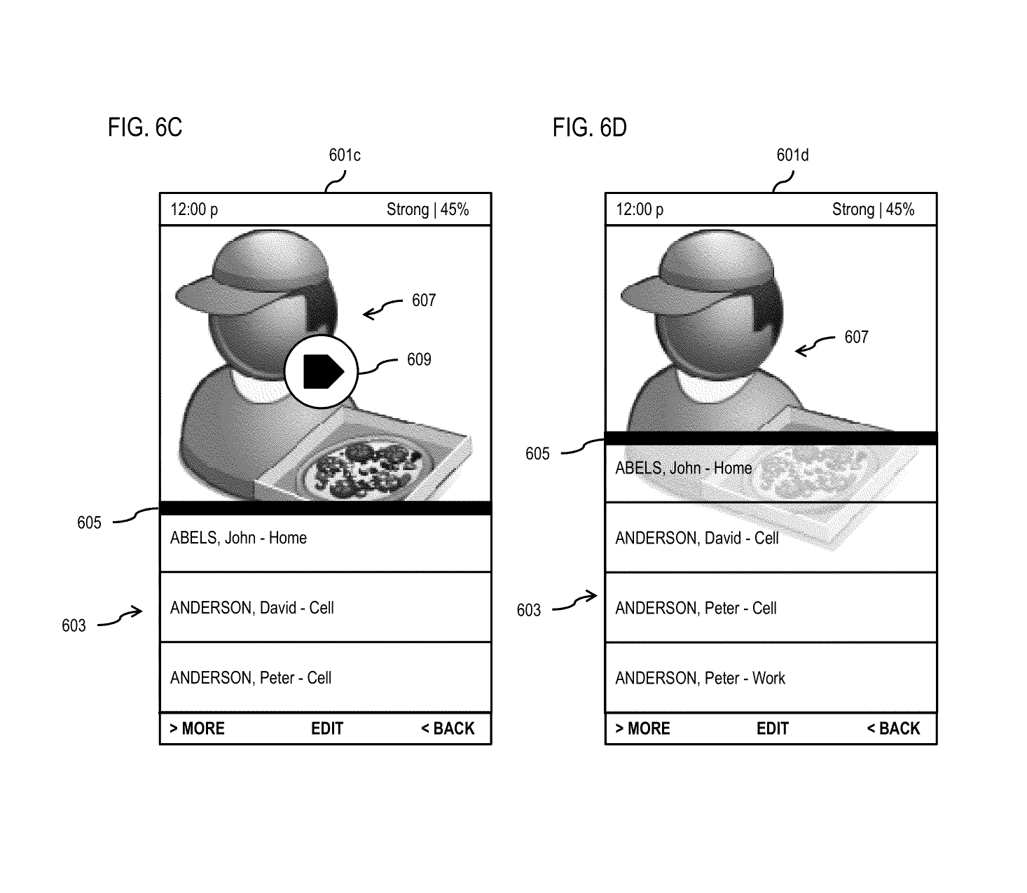

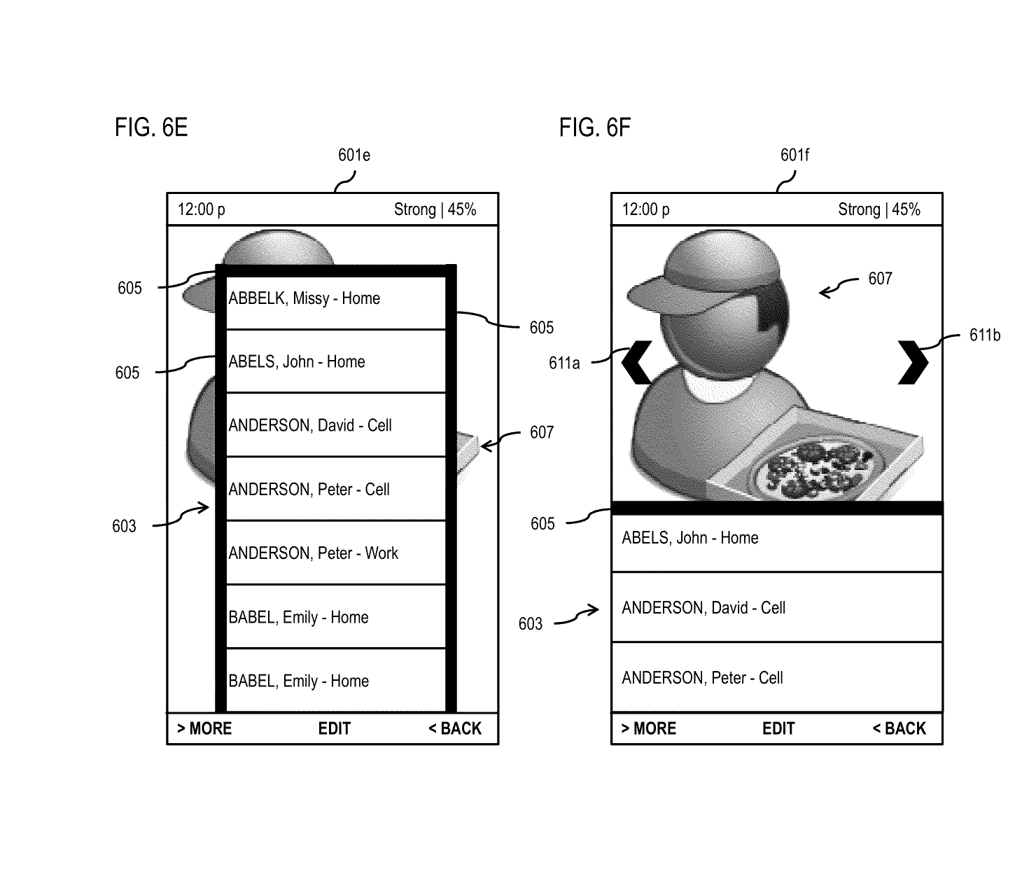

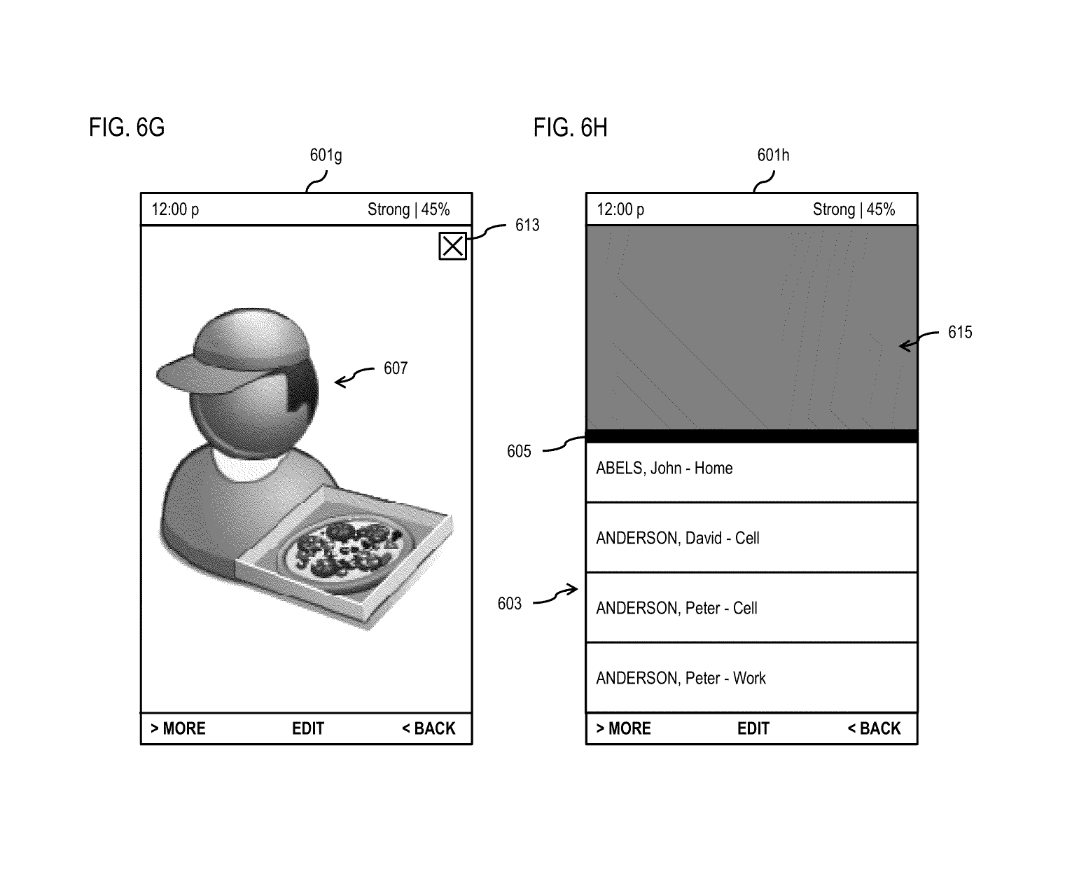

FIGS. 6A-6H are diagrams of user interfaces utilized in the processes of FIGS. 3-5, according to various embodiments. FIG. 6A illustrates a display 601a associated with a UE 101 that includes the user interface 603. By way of example, the user interface 603 is in the form of an application including a list of contacts, such as a list of contacts in a phonebook for a mobile device. The user interface 603 includes an endpoint 605 at the top of the list of contacts. Although not illustrated, the user interface 603 also includes another endpoint at the bottom of the list of contacts. Additionally, the right and left sides of the list of contacts also constitute endpoints. FIG. 6A illustrates the situation where a user of the UE 101 associated with the user interface 603 performed an interaction with the user interface 603 to reveal the endpoint 605 at the top of the first user interface 603. The interaction may include, for example, a swipe of the user's finger down the display 601a, where the user interface 603 is associated with a touch-sensitive display.

FIG. 6B illustrates the display 601b where the user interface 603 has been dragged farther down the display 601b to transition between a first user interface 603 and a second user interface 607. The transition may be the result of an interaction that caused the first user interface 603 to be moved farther down the display 601b, such as where the user's finger continued moving down across the display 601b. Here, for example, the transition between the first user interface 603 and the second user interface 607 included the first user interface 603 kinetically scrolling down to reveal a static second user interface 607 at the transition point of the endpoint 605. However, the transition may occur according to any of the above discussed methods. For example, after moving the first user interface 603 down the display 601b, a blank background may be revealed in the background of the display 601b until a second interaction with the first user interface 603 that causes the second user interface to be revealed. The second user interface 607 may be associated with one or more applications and/or one or more information presentations.

FIG. 6C illustrates the display 601c of the UE 101 that is similar to the display 601b in FIG. 6B. However, the second user interface 607 in FIG. 6C is associated with an application. The application associated with the second user interface 607 may be activated by an interaction that selects the indicator 609. Such an interaction may include, for example, the user selecting the indicator 609 with a finger for a touch-sensitive display. Although FIG. 6C includes the indicator 609 to activate the application associated with the second user interface 607, the application may be activated by other interactions that are not necessarily associated with the indicator 609. For example, the user may also flick their finger up and/or down across a portion of the display 601c associated with the second user interface 607 to activate the application.

FIG. 6D illustrates the display 601d of the UE 101 illustrating a different transition than the transition illustrated in FIGS. 6A through 6C. By way of example, the transition illustrated in FIG. 6D includes the first user interface 603 moving down across the display 601b against a static second user interface 607. The first user interface 603 also becomes semi-transparent during the transition such that the second user interface 607 is visible behind the first user interface 603 during the transition. In one embodiment, the level of transparency is static during the transition. In one embodiment, the level of transparency varies in relation to the extent the first user interface 603 transitions across the second user interface 607.

FIG. 6E illustrates the display 601e of the UE 101 illustrating another transition between the first user interface 603 and the second user interface 607. By way of example, an interaction to cause the transition may correspond to a pinch-zooming or a corner-zooming associated with the first user interface 603 that reveals the endpoints associated with the top, right and left sides of the first user interface 603 (for example if the list of contacts was near the top of the list, such that, when the list is reduced in scale the top endpoint is also revealed). The pinch-zoom may transition the first user interface to the second user interface, regardless of the duration that the pinch-zoom interaction is held. In one embodiment, the pinch-zoom may transition the first user interface to the second user interface if the pinch-zoom interaction is held for a pre-defined duration of time. Thus, the entire first user interface 603 reduces in scale to reveal the second user interface 607 behind the first user interface 603. Although illustrated at the top of the list of contacts of the first user interface 603, such an interaction may be useful for transitioning between the first user interface 603 and the second user interface 607 where the first user interface 603 is associated with an application that includes a long list, such as a long list of contacts, and navigating to the top or bottom of the list of contacts would take a prohibitively long amount of time as compared to merely performing a pinch-zoom action on the first user interface 603. In one embodiment, the transitions illustrated in FIGS. 6D and 6E could be combined to have the first user interface 603 both reduce in scale and become semi-transparent, as yet another exemplary embodiment of a transition.

FIG. 6F illustrates the display 601f of the UE 101 illustrating the ability to alternate through one or more applications and/or one or more information presentations associated with the second user interface 607. In one embodiment, the second user interface includes indicators 611a and 611b that allow a user to alternate through the applications and/or information presentations. By way of example, the user may select one of the indicators 611a or 611b with an interaction to alternate through the applications and/or information presentations associated with the second user interface 607. In one embodiment, the user may alternate through the applications and/or information presentations associated with the second user interface 607 with another interaction not associated with the indicators, if the indicators are or are not present, such as a flick of the user's finger to the right and/or left for a touch-sensitive display.

FIG. 6G illustrates the display 601g of the UE 101 illustrating the situation where, after the user transition to, or activates, the second user interface 607, the second user interface 607 occupies substantially all of the display 601g. In one embodiment, the second user interface 607 includes an indicator 613 that can be activated with an interaction to cause the second user interface 607 to return back to the first user interface 603. In one embodiment, the interaction may include the user activating the indicator 613 by touching the indicator with the user's finger for a duration of time when the display 601g is associated with a touch sensitive display. In one embodiment, the user may exit the second user interface 607 and return back to the first user interface by using any type of interaction associated with the second user interface 607 when the second user interface 607 occupies substantially all of the display 601g. For example, the user may interact with the second user interface 607 with a flick of their finger up, down, right or left to exit the second user interface. In one embodiment, the UE 101 associated with the display 601g may include a hardware element that returns back to the first user interface from the second user interface.

FIG. 6H illustrates the display 601g of the UE 101 illustrating the situation where the user has deactivated the transition between the first user interface 603 and a second user interface 607. Instead, upon revealing the endpoint 605 associated with the first user interface 603 and continuing to move the first user interface 603 down the display 601h, a plain background is revealed behind the first user interface 603 rather than a second user interface. In which case, upon the user ending the interaction that causes the first user interface 603 to move down across the display 601h, the first user interface 603 bounces back to no longer reveal the endpoint and hide the background 615 using, for example, a bounce-back animation.

The processes described herein for integrating user interfaces may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

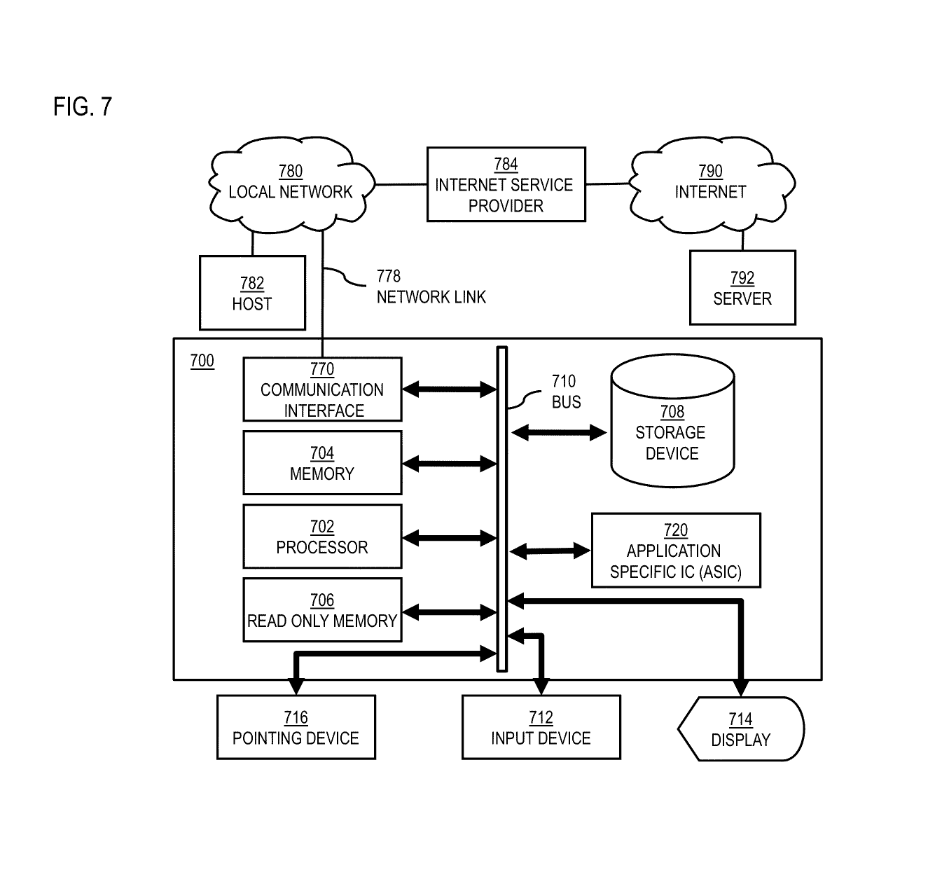

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to integrate user interfaces as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of integrating user interfaces.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to integrating user interfaces. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for integrating user interfaces. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for integrating user interfaces, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for integrating user interfaces at the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to integrate user interfaces as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of integrating user interfaces.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to integrate user interfaces. The memory 805 also stores the data associated with or generated by the execution of the inventive steps.

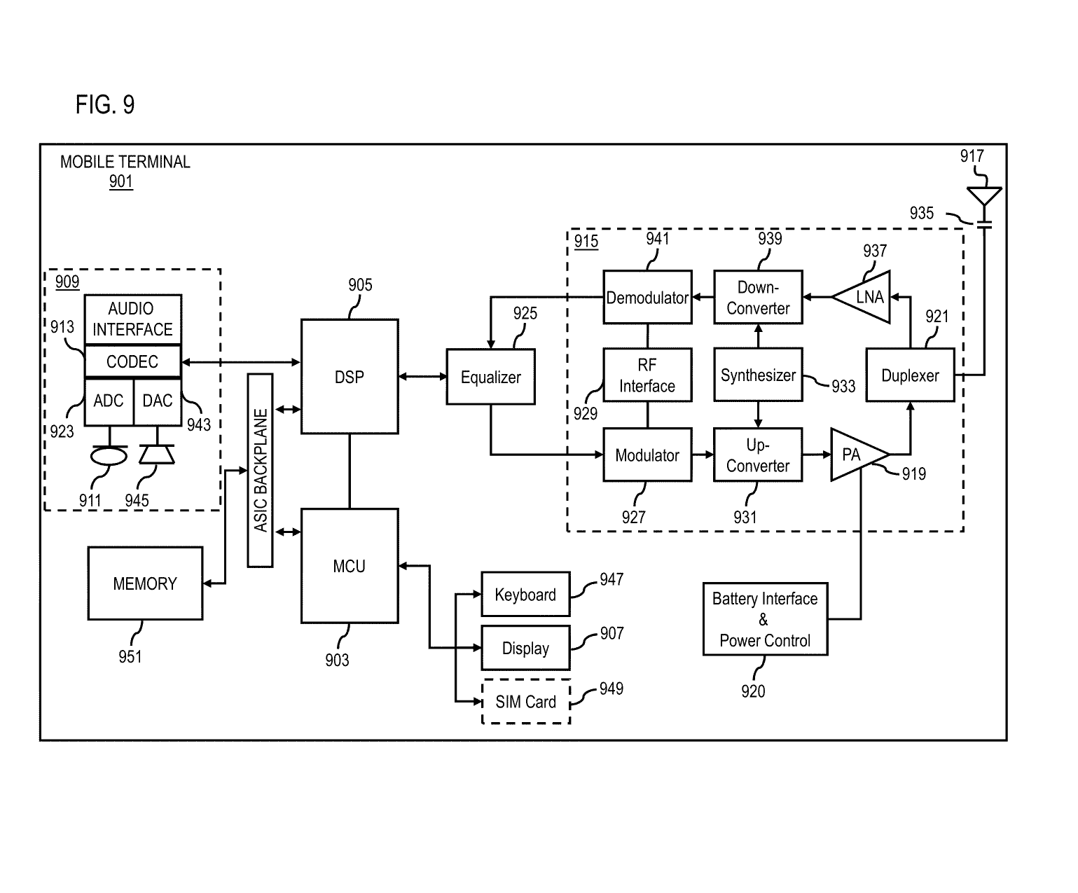

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of integrating user interfaces. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of integrating user interfaces. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to integrate user interfaces. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a rendering of a first user interface associated with an application for presenting at least one user interface element including at least one endpoint;
a first interaction with the first user interface to cause, at least in part, a revelation of the at least one endpoint; and
a second interaction at the at least one endpoint to cause, at least in part, a transition to a second user interface associated with one or more other applications, one or more information presentations, or a combination thereof.

2. A method of claim of 1, wherein the first user interface presents the at least one user interface element as a kinetically scrolling list, and wherein the revelation of the at least one endpoint comprises at least one bounce-back animation.

3. A method of claim 1, wherein the (1) data and/or (2) information and/or (3) at least one signal are further based, at least in part, on the following:
a processing of the second interaction to determine a duration of the second interaction; and
the transition to the second user interface based, at least in part, on a determination that the duration meets or exceeds a predetermined threshold value.

4. A method of claim 1, wherein the (1) data and/or (2) information and/or (3) at least one signal are further based, at least in part, on the following:
a third interaction with the second user interface to cause, at least in part, a return to the first user interface.

5. A method of claim 1, wherein the (1) data and/or (2) information and/or (3) at least one signal are further based, at least in part, on the following:
an activation of the one or more other applications, the one or more information presentations, or a combination thereof during the transition, after the transition, or a combination thereof.

6. A method of claim 1, wherein the (1) data and/or (2) information and/or (3) at least one signal are further based, at least in part, on the following:
an alternation of the one or more applications, the one or more information presentations, or a combination thereof for one or more subsequent revelations of the at least one endpoint.

7. A method of claim 1, wherein the (1) data and/or (2) information and/or (3) at least one signal are further based, at least in part, on the following:
a rendering of the first user interface with a transparency effect to reveal the second user interface;
an animation of the move of the first user interface to reveal the second user interface; or
a combination thereof.

8. A method of claim 1, wherein the (1) data and/or (2) information and/or (3) at least one signal are further based, at least in part, on the following:
a fourth interaction with the first user interface, the second user interface, or a combination thereof to cause, at least in part, an indication of user preference information with respect to the one or more applications, the one or more information presentations, or a combination thereof.

9. A method of claim 1, wherein the second interaction is at least one gesture that is not used in the first user interface, the application associated with the first user interface, or a combination thereof.

10. A method of claim 1, wherein the (1) data and/or (2) information and/or (3) at least one signal are further based, at least in part, on the following:
context information associated with the first user interface, the at least one user interface element, a device associated with the first user interface, or a combination thereof; and
the transition, the second user interface, the one or more applications, the one or more information presentations, or a combination thereof based, at least in part, on the context information.

11. An apparatus comprising:
at least one processor; and
at least one memory including computer program code for one or more programs, the at least one memory and the computer program code configured to, with the at least one processor, cause the apparatus to perform at least the following,
determine a rendering of a first user interface associated with an application for presenting at least one user interface element including at least one endpoint;
determine a first interaction with the first user interface to cause, at least in part, a revelation of the at least one endpoint; and
determine a second interaction at the at least one endpoint to cause, at least in part, a transition to a second user interface associated with one or more other applications, one or more information presentations, or a combination thereof.

12. An apparatus of claim of 11, wherein the first user interface presents the at least one user interface element as a kinetically scrolling list, and wherein the revelation of the at least one endpoint comprises at least one bounce-back animation.

13. An apparatus of claim 11, wherein the apparatus is further caused to:
process and/or facilitate a processing of the second interaction to determine a duration of the second interaction; and
cause, at least in part, the transition to the second user interface based, at least in part, on a determination that the duration meets or exceeds a predetermined threshold value.

14. An apparatus of claim 11, wherein the apparatus is further caused to:
determine a third interaction with the second user interface to cause, at least in part, a return to the first user interface.

15. An apparatus of claim 11, wherein the apparatus is further caused to:
cause, at least in part, an activation of the one or more other applications, the one or more information presentations, or a combination thereof during the transition, after the transition, or a combination thereof.

16. An apparatus of claim 11, wherein the apparatus is further caused to:
cause, at least in part, an alternation of the one or more applications, the one or more information presentations, or a combination thereof for one or more subsequent revelations of the at least one endpoint.

17. An apparatus of claim 11, wherein the apparatus is further caused to:
cause, at least in part, a rendering of the first user interface with a transparency effect to reveal the second user interface;
cause, at least in part, an animation of the move of the first user interface to reveal the second user interface; or
a combination thereof.

18. An apparatus of claim 11, wherein the apparatus is further caused to:
determine a fourth interaction with the first user interface, the second user interface, or a combination thereof to cause, at least in part, an indication of user preference information with respect to the one or more applications, the one or more information presentations, or a combination thereof.

19. An apparatus of claim 11, wherein the second interaction is at least one gesture that is not used in the first user interface, the application associated with the first user interface, or a combination thereof.

20. An apparatus of claim 11, wherein the apparatus is further caused to:
determine context information associated with the first user interface, the at least one user interface element, a device associated with the first user interface, or a combination thereof; and
determine the transition, the second user interface, the one or more applications, the one or more information presentations, or a combination thereof based, at least in part, on the context information.

21-48. (canceled)
